(19) United States
(12) Patent Application Publication
(10) Pub. No.: US 2012/0091298 A1
(43) Pub. Date: Apr. 19, 2012

(54) Supporting structure for display device

(75) Inventor: Wen-Hung Huang, Tucheng City (TW)

(73) Assignee: Hannspree, Inc., Taipei County (TW)

(21) Appl. No.: 12/929,436

(22) Filed: Jan. 25, 2011

(30) Foreign Application Priority Data
Oct. 13, 2010 (TW) 099134850

(51) Int. Cl. F16M 11/02

(52) U.S. Cl. 248/176.1

(57) ABSTRACT

The present invention is to provide a supporting structure including a main supporting element and an auxiliary supporting element. The main supporting element has two sides adjacent to an end thereof each provided with at least a projection securely and removably inserted into assembly holes formed on a rear side of a display device, an opposite end being bent into a hook portion, and a receiving cavity formed on a side thereof opposite to the hook portion. The auxiliary supporting element is pivotally connected to the main supporting element within the receiving cavity and can be rotated out from the receiving cavity for enabling an edge thereof to press against an inner wall of the receiving cavity and an opposite edge thereof to form a supporting plane together with an edge of the main supporting element, thereby supporting the display device and keeping the display device in a standing position.

### FIELD OF THE INVENTION

The present invention relates to a supporting structure for a display device, which includes a main supporting element capable of being securely and removably inserted into assembly holes formed on a rear side of the display device and an auxiliary supporting element pivotally connected to the main supporting element and having one edge pressing against the main supporting element and an opposite edge forming a supporting plane together with one edge of the main supporting element, thereby supporting the display device on a surface (e.g., a tabletop) and keeping the display device in a standing position.

### BACKGROUND OF THE INVENTION

Digital photo frames—one of the hottest new products on the market in recent years—are generally categorized as an application of medium-size liquid crystal displays (LCDs). While current sales are only moderate, digital photo frames have become increasingly popular in the United States and Europe and begun to sell well in emerging countries. Related statistics show that about four million digital photo frames were sold worldwide in 2009 alone, and the number of 2010 is expected to exceed ten million; the market of digital photo frames should not be underestimated.

Aside from digital photo frames, LCDs are applicable to other fields as well. For instance, they can be used as the display devices of computers or used in LCD television sets. LCDs are relatedly lighter than the traditional cathode ray tube (CRT) displays and have therefore gradually replaced the CRT displays. As used herein, the term “display device” refers to the various types of LCDs mentioned above, and the supporting structure of such display devices is described in more detail as follows.

Typically, a base is provided at the back of a display device. The base has a top end connected to the bottom side of the display device and a bottom end configured to lie on a supporting surface (e.g., a tabletop) and thereby keep the display device in a standing position. In order to facilitate angular adjustment of the display device, a rotating mechanism may be provided on the base or the display device itself so that the display device can be rotated to the desired viewing angle. Moreover, some users would like to hang the display device on a hook, instead of or in addition to supporting the display device on the base, so as to enable flexible placement of the display device.

Hence, a variety of movable supporting structures were developed, such as U.S. Pat. No. 6,651,943 disclosed a supporting structure, as shown in FIGS. 1 and 2. A fixing seat 11 is embedded in the rear side of a display device 10 and mounted with a fixing plate 12. The left and right sides of the fixing plate 12 are each extended with a pivotal connection plate 120, wherein each pivotal connection plate 120 is formed with a pivot hole (not shown). In addition, a generally U-shaped stand 13 includes two free ends bent inward to form pivotal connection portions 130 respectively. Each pivotal connection portion 130 is pivotally connected to the pivot hole of the corresponding pivotal connection plate 120, thus allowing the stand 13 to be rotated with respect to the fixing plate 12. Furthermore, as shown in FIG. 1, an anti-slip sleeve 131 is provided on one side of the stand 13 that is distant from the pivotal connection portions 130. The anti-slip sleeve 131 is an annular resilient body, generally made of rubber, and is mounted on the stand 13 to increase the friction between the stand 13 and the contact surface. The supporting structure of the afore-cited US patent further includes a circular cap 14 fitted on the fixing seat 11 to cover the fixing plate 12. Hence, when it is desired to place the display device 10 on a tabletop, the stand 13 is rotated away from the display device 10 to form an appropriate angle therewith, allowing the bottom sides of both the display device 10 and the stand 13 to contact with the tabletop and thereby support the display device 10.

If it is desired to hang the display device 10, the stand 13 can be rotated upward and hung on a hook, so that the display device 10 is hung stably at the intended position. However, the foregoing supporting structure still leaves much room for improvement. First of all, while the display device 10 is in the standing position, the bottom side of the display device 10 is in contact with the tabletop and therefore very likely to be scratched due to the friction between the bottom side of the display device 10 and the tabletop; as a result, the outer appearance of the display device 10 will be damaged, which is highly undesirable. Moreover, when hanging the display device 10, the pivotal connection positions between the pivotal connection plates 120 and the stand 13 are invariable. In other words, the height at which the stand 13 is pivotally connected to the display device 10 (or more specifically the fixing plate 12) cannot be changed. As it is impossible to fine-tune the hanging height of the display device 10, the supporting structure is quite inconvenient in terms of its hanging function.

Therefore, the issue to be addressed by the present invention is to improve the conventional display device supporting structures by designing a supporting structure capable of supporting or hanging a display device and fine-tuning the height thereof so that both the height and angle of the display device can be easily adjusted according to practical needs.

### BRIEF SUMMARY OF THE INVENTION

In view of the various drawbacks of the conventional supporting structures configured for display devices, the inventor of the present invention conducted extensive research and repeated trials and finally succeeded in developing a supporting structure as disclosed in herein for use with a display device. The disclosed supporting structure, capable of supporting and hanging, can be rapidly installed on a display device and readily adjust the height and angle of the display device according to where the display device is placed.

It is an object of the present invention to provide a supporting structure for a display device, wherein the supporting structure is configured to support or hang a display device (e.g., an LCD, a digital photo frame, etc.) and includes a main supporting element and an auxiliary supporting element. The main supporting element is a curved plate and has at least a projection and a hook portion. The projections are disposed in a first end of the main supporting element, and the hook portion is disposed in a second end of said main supporting element. The projections are correspondingly disposed in adjacent two sides of the main supporting element and are movably disposed in assembly holes arranged in the rear of the display device. The hook portion is bent. The main supporting element further includes a receiving cavity opposite to the hook portion, and the receiving cavity has two inner surfaces each provided with a first pivotal connection portion (e.g., a pivot hole). The auxiliary supporting element corresponds in shape to the receiving cavity, and has two second pivotal connection portions (e.g., a pivot) disposed in two sides of the auxiliary supporting element respectively. The second pivotal connection portions are movably connected with the corresponding first pivotal connection portions respectively. By means of pivotal connection between the corresponding first and second pivotal connection portions, the auxiliary supporting element is rotatable about the first and second pivotal connection portions and can be rotated into or out of the receiving cavity so as to be stored in or positioned outside the receiving cavity. The structural features of the present invention allow a user to rotate the auxiliary supporting element easily out of the receiving cavity. And once outside the receiving cavity, the auxiliary supporting element has one edge pressing against the inner wall of the receiving cavity and an opposite edge forming a supporting plane together with one edge of the main supporting element, thereby supporting the display device on a surface (e.g., a tabletop) and keeping the display device in a standing position. Besides, the auxiliary supporting element can also be easily rotated into the receiving cavity and stored therein, thus allowing the hook portion of the main supporting element to hang on a fixed object (e.g., a hook, a projecting edge of a cupboard, a windowsill, etc.) and thereby hang the display device stably on the fixed object. It is particularly worth mentioning that, as the projections in the present invention are securely and removably insertable in the assembly holes on the rear side of the display device, it is feasible to design several sets of assembly holes on the rear side of the display device, wherein the plural sets of assembly holes are of different heights. Thus, the positions at which the projections are securely and removably inserted into the display device can be adjusted according to where the display device is placed, so as to change the standing angle or hanging height of the display device.

It is another object of the present invention to provide the foregoing supporting structure, wherein the side of the main supporting element where the receiving cavity is formed is further provided with at least one groove. Each groove has two corresponding inner sides that are each formed with a third pivotal connection portion (e.g., a pivot hole). The third pivotal connection portions of each groove correspond in position to the second pivotal connection portions so that the second pivotal connection portions of the auxiliary supporting element can be respectively and pivotally connected to the third pivotal connection portions, allowing one edge of the auxiliary supporting element to press against the inner wall of the groove while the opposite edge of the auxiliary supporting element and the main supporting element jointly support the display device.

Yet another object of the present invention is to provide the foregoing supporting structure, wherein the end of the auxiliary supporting element that the second pivotal connection portions are adjacent to is formed with slots. The slots are adjacent to the second pivotal connection portions respectively so as form two resilient arms. When pressed with fingers, the two resilient arms are moved inward and brought close to each other, thus allowing the auxiliary supporting element to be removed from or installed in the receiving cavity (or one of the at least one groove).

It is still another object of the present invention to provide the foregoing supporting structure, wherein the receiving cavity has two lateral sides each concavely provided with a recess, and the recesses are adjacent to the first pivotal connection portions respectively. Thus, when it is desired to remove the auxiliary supporting element from the receiving cavity, the user can put his/her fingers into the recesses, press on the auxiliary supporting element, and then take it out.

### BRIEF DESCRIPTION OF THE SEVERAL VIEWS OF THE DRAWINGS

The structure as well as a preferred mode of use, further objects, and advantages of the present invention will be best understood by referring to the following detailed description of an illustrative embodiment in conjunction with the accompanying drawings, in which:

FIG. 1 is a perspective view of a display device and a conventional supporting structure installed thereon;

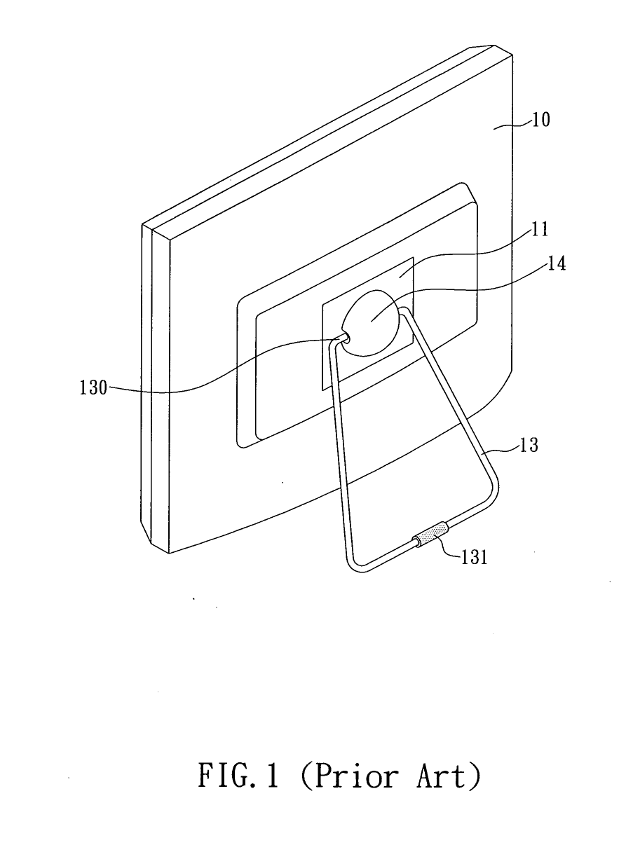

FIG. 2 is a perspective view of the conventional supporting structure depicted in FIG. 1;

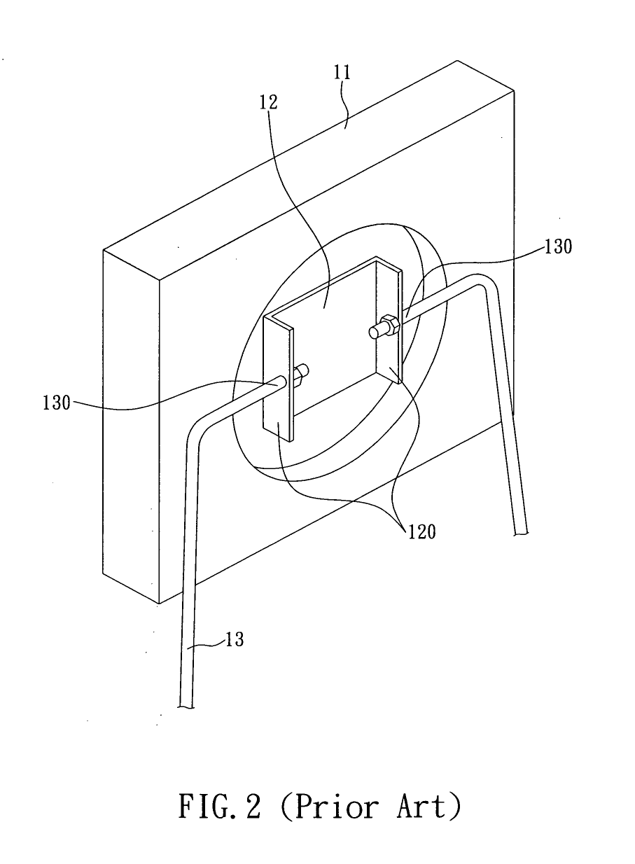

FIG. 3 is an exploded perspective view of a supporting structure according to the present invention;

FIG. 4 is a side elevation showing a first state in which the supporting structure depicted in FIG. 3 is used;

FIG. 5 is a side elevation showing a second state in which the supporting structure depicted in FIG. 3 is used; and

FIG. 6 is a side elevation showing a third state in which the supporting structure depicted in FIG. 3 is used.

### DETAILED DESCRIPTION OF THE INVENTION

The inventor of the present invention has long been engaged in the research and development of digital photo frames and like display devices. During this process, the inventor has found that the conventional supporting structures for display devices can only support the display devices on a flat surface and are unable to also provide a hanging function; consequently, the placement of display devices are subject to many limitations. While some fellow colleagues in the industry have devoted themselves to finding a solution to the aforesaid problems, their products so far are still incapable of fine-tuning the height of a display device and preventing the bottom side of the display device from being scratched by the contact surface. In consideration of the above, the inventor came up with the concept of forming assembly holes on the rear side of a display device and providing a main supporting element which is securely and removably insertable into the assembly holes so as to provide both supporting and hanging functions.

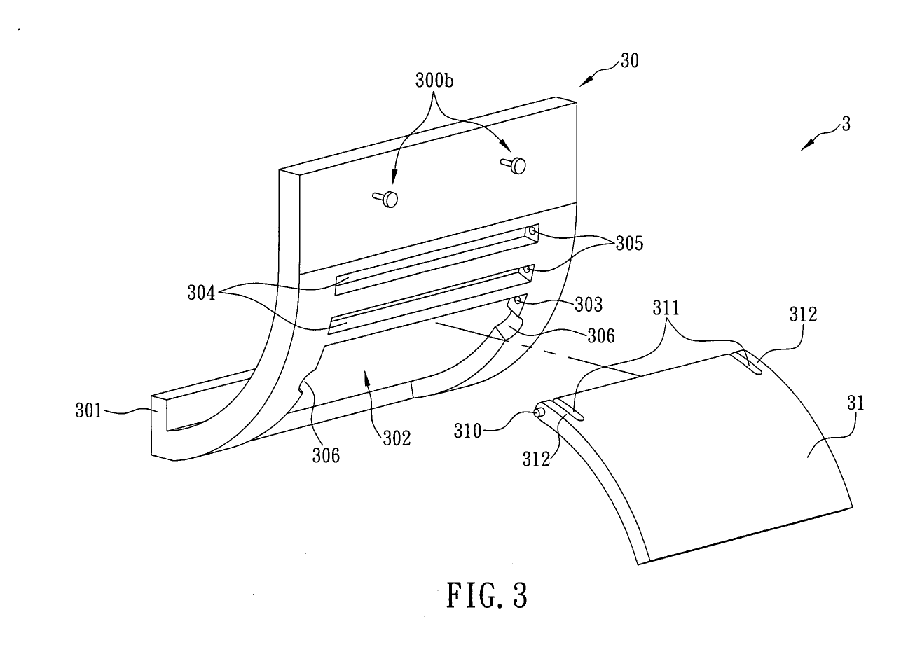

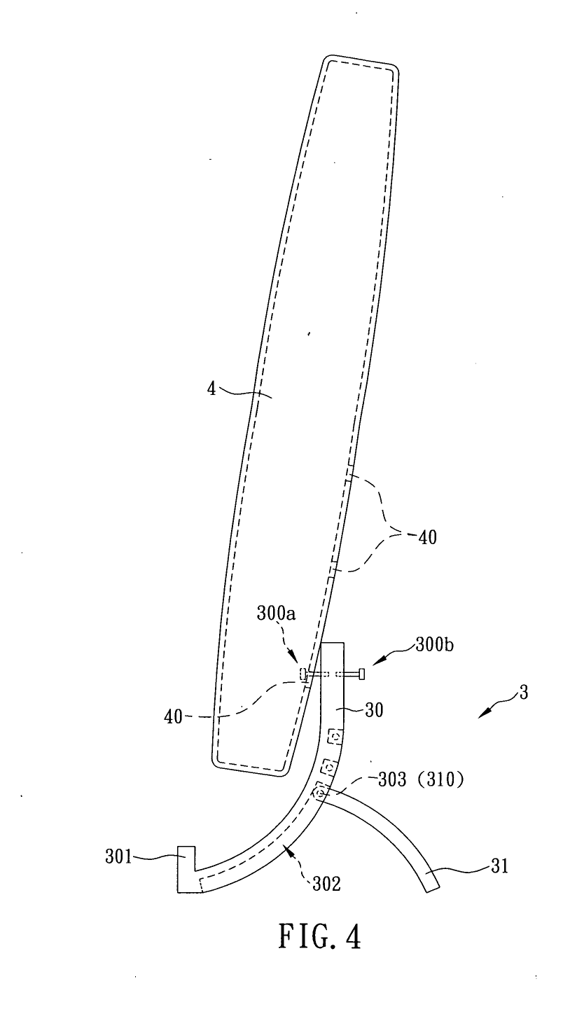

The present invention provides a supporting structure for a display device. Referring to FIGS. 3 and 4 for a preferred embodiment of the present invention, a supporting structure 3 includes a main supporting element 30 and an auxiliary supporting element 31 which are made of plastic or metal. The main supporting element 30 is a curved plate and has two sides which are each protrudingly provided with two projections 300a, 300b. The projections 300a, 300b are adjacent to one end of the main supporting element 30. Referring to FIG. 4 for a display device 4, the rear side of the display device 4 is formed with several sets of assembly holes 40, and the plural sets of assembly holes 40 have different heights. The projections 300a on one side of the main supporting element 30 are securely and removably inserted in a chosen set of assembly holes 40 on the rear side of the display device 4. The opposite end of the main supporting element 30 is bent and thus forms a hook portion 301. In addition, the side of the main supporting element 30 that is opposite to the hook portion 301 is concavely provided with a receiving cavity 302. As shown in FIG. 3, the receiving cavity 302 has two corresponding inner sides, each provided with a first pivotal connection portion 303. In this embodiment, each first pivotal connection portion 303 is a pivot hole.

Referring again to FIG. 3, the shape of the auxiliary supporting element 31 corresponds to the receiving cavity 302. The auxiliary supporting element 31 has two opposite lateral sides each provided with a second pivotal connection portion 310. The second pivotal connection portions 310 are adjacent to one end of the auxiliary supporting element 31. In this embodiment, the second pivotal connection portions 310 are pivots and correspond in position to the first pivotal connection portions 303. Therefore, each second pivotal connection portion 310 can be pivotally connected to the corresponding first pivotal connection portion 303, thereby assembling the auxiliary supporting element 31 to the main supporting element 30. Once assembled, the auxiliary supporting element 31 is rotatable along the first and second pivotal connection portions 303, 310 and can be rotated into or out of the receiving cavity 302 so as to be stored in or positioned outside the receiving cavity 302. With reference to FIG. 4, wherein the auxiliary supporting element 31 has been rotated out of the receiving cavity 302, the auxiliary supporting element 31 has one edge pressing against the inner wall of the receiving cavity 302 and an opposite edge (i.e., the bottom side) forming a supporting plane together with the bottom side of the main supporting element 30. As the rear side of the display device 4 leans against the main supporting element 30, the display device 4 is supported and kept in a standing position by the supporting structure 3 on a surface (e.g., a tabletop) so as to be viewed.

It should be noted that, as shown in FIG. 4, the rear side of the display device 4 is formed with plural sets of assembly holes 40 into which the projections 300a can be inserted; hence, according to practical needs, a user can insert the projections 300a into assembly holes 40 of different heights to fine-tune the height of the display device 4. Furthermore, referring to FIG. 3, in order to provide the supporting structure 3 with angular variability and allow the display device 4 leaning thereon (see FIG. 4) to be positioned at different angles, two grooves 304 are additionally provided on the side of the main supporting element 30 that is formed with the receiving cavity 302. Each groove 304 has two corresponding inner sides which are provided with two third pivotal connection portions 305 (pivot holes) respectively. The third pivotal connection portions 305 in each groove 304 correspond in position to the second pivotal connection portions 310, so that the second pivotal connection portions 310 of the auxiliary supporting element 31 can be pivotally connected to the third pivotal connection portions 305 in any of the grooves 304. Once such pivotal connection is formed, the auxiliary supporting element 31 has one edge pressing against the inner wall of the corresponding groove 304 and the opposite edge supporting the display device 4 jointly with the main supporting element 30 (as shown in FIG. 4). However, the number and configuration of the grooves 304 are not limited to those described above. While designing products based on the present invention, manufacturers may increase or decrease the number of the grooves 304, change the dimensions of each groove 304, or even increase the vertical height of each groove 304 so as to provide a plurality of third pivotal connection portions 305 on each of the two corresponding inner sides of each groove 304. All changes easily conceivable by a person skilled in the art should fall within the scope of the present invention. Furthermore, while the first and third pivotal connection portions 303, 305 in this embodiment are pivot holes, and the second pivotal connection portions 310 are pivots, the present invention is not limited to such an arrangement. The effects described above are equally achievable by forming the first and third pivotal connection portions 303, 305 as pivots, and the second pivotal connection portions 310 as pivot holes.

Referring to FIG. 3, in order to facilitate removal of the auxiliary supporting element 31, two slots 311 are provided at one end of the auxiliary supporting element 31 and are adjacent to the second pivotal connection portions 310 respectively, so as for the auxiliary supporting element 31 to form two resilient arms 312. In addition, the two lateral sides of the receiving cavity 302 are each concavely provided with a recess 306, and the recesses 306 are adjacent to the first pivotal connection portions 303 respectively. A user can put his/her fingers into the recesses 306 and press the two resilient arms 312 with the fingers so that the two resilient arms 312 are moved inwardly toward each other. Consequently, the second pivotal connection portions 310 are disengaged respectively from the first pivotal connection portions 303, allowing the user to remove the auxiliary supporting element 31 from the receiving cavity 302 and connect the auxiliary supporting element 31 to other pivotal connection positions. However, the number of the resilient arms 312 is not limited to the above; the foregoing effect can be achieved by providing the auxiliary supporting element 31 with at least one resilient arm 312.

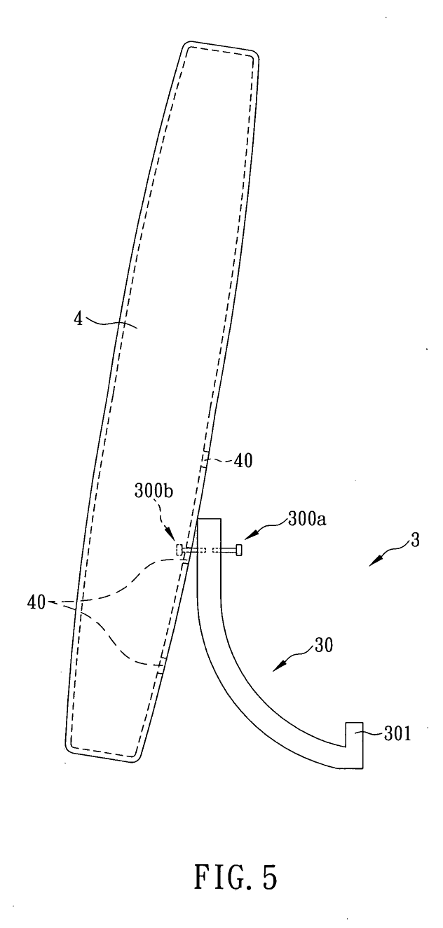

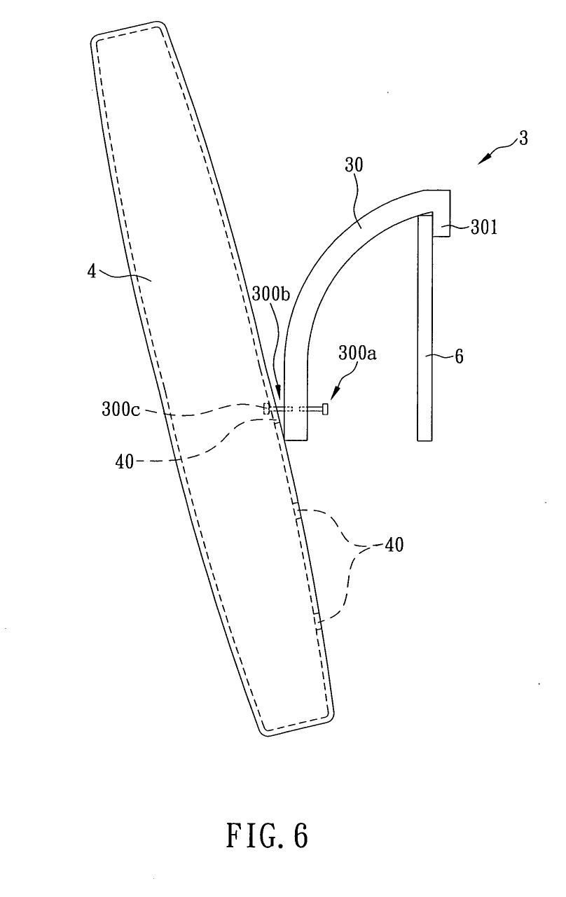

The present embodiment can be used in ways other than described above. For example, FIG. 5 shows a second state in which the present embodiment is used. In this state, the auxiliary supporting element 31 is stored in the receiving cavity 302; hence, for the sake of simplicity of the drawing, the auxiliary supporting element 31, the receiving cavity 302, and the grooves 304 are omitted from FIG. 5. The projections 300b on the other side of the main supporting element 30 are inserted in the chosen assembly holes 40 of the display device 4 while the hook portion 301 of the main supporting element 30 located in another side from the display device 4. Thus, the display device 4 leans against the main supporting element 30 and is thereby kept in a standing position. A third state in which the present embodiment can be used is illustrated in FIG. 6, from which the auxiliary supporting element 31, the receiving cavity 302, and the grooves 304 are also omitted. In the third state, the projections 300b of the main supporting element 30 are inserted in the chosen assembly holes 40 of the display device 4. Moreover, the ends of the projections 300b that face away from the main supporting element 30 are each provided with an engaging portion 300c. Each engaging portion 300c has a larger diameter than the projection 300b where each said engaging portion 300c is provided. The engaging portions 300c are hooked respectively to the inner sides of the assembly holes 40 to prevent the display device 4 from sliding off the main supporting element 30. Meanwhile, the hook portion 301 is hooked to a fixed object 6 so that the display device 4 is stably hung. As the rear side of the display device 4 is formed with plural sets of assembly holes 40 to be inserted by the projections 300b, a user may insert the projections 300b into the assembly holes 40 of the desired height according to practical needs, so as to fine-tune the height of the display device 4, which is unattainable by the connectional supporting structures. In other words, depending on where the display device 4 is placed, the positions at which the projections 300b are inserted into the display device 4 can be adjusted to change the hanging height of the display device 4.

In the foregoing three states in which the present embodiment can be used, the position at which the main supporting element 30 is connected to the display device 4 can be changed to easily fine-tune the height and angle of the display device 4. Thus, not only are the drawbacks of the conventional supporting structures effectively overcome, but also the convenience of use of the supporting structure 3 is significantly enhanced.

While the invention has been described by means of specific embodiments, numerous modifications and variations could be made thereto by those skilled in the art without departing from the scope and spirit of the invention set forth in the claims.

1. A supporting structure for a display device, comprising:
a main supporting element having at least two projections and a hook portion, said at least two projections disposed in a first end of said main supporting element and each having one end movably disposed in an assembly hole arranged in a rear surface of said display device, said hook portion disposed in a second end of said main supporting element and being in a bent shape, wherein said main supporting element includes a receiving cavity opposite to said hook portion and at least a groove disposed therein, said receiving cavity has two opposite inner surfaces each provided with a first pivotal connection portion and at least a recess disposed adjacent to said first pivotal connection portion, and said groove has two third pivotal connection portions disposed in two opposite inner surfaces of said groove; and
an auxiliary supporting element corresponding in shape to said receiving cavity, said auxiliary supporting element having two second pivotal connection portions disposed in two sides of said auxiliary supporting element respectively, and said second pivotal connection portions movably connected with said first pivotal connection portions respectively, wherein said auxiliary supporting element is rotated outward about said first and second pivotal connection portions and positioned outside said receiving cavity, one edge of said auxiliary supporting element leans against an inner wall of said receiving cavity, an opposite edge of the auxiliary supporting element forms a supporting plane together with an edge of said main supporting element, said second pivotal connection portions correspond in positions to said third pivotal connection portions respectively, and at least a slot is disposed in said auxiliary supporting element adjacent to each said second pivotal connection portion such that said auxiliary supporting element forms at least a resilient arm between the second pivotal connection portion and the slot.

2-4. (canceled)

5. The supporting structure of claim 1, wherein said one end of said projection comprising an engaging portion disposed away from said main supporting element, wherein said engaging portion has a diameter larger than a diameter of said projection.

6. The supporting structure of claim 5, wherein the first and the third pivotal connection portions are pivot holes, and the second pivotal connection portions are pivots.

7. The supporting structure of claim 5, wherein the first and the third pivotal connection portions are pivots, and the second pivotal connection portions are pivot holes.

8. The supporting structure of claim 6, wherein the main supporting element is a curved plate.

9. The supporting structure of claim 7, wherein the main supporting element is a curved plate.
